(19) United States
(12) Patent Application Publication
(10) Pub. No.: US 2026/0298665 A1
(43) Pub. Date: Oct. 1, 2026

(54) Real-time Emergency Vehicle Route Display

(71) Applicant: Cy Shim, Forest Park, IL (US)

(72) Inventor: Cy Shim, Forest Park, IL (US)

(21) Appl. No.: 19/091,831

(22) Filed: Mar. 27, 2025

(51) Int. Cl. G01C 21/00; G01C 21/34; G01C 21/36

(52) U.S. Cl. CPC G01C 21/3889; G01C 21/3461; G01C 21/3629; G01C 21/3632; G01C 21/3694; G01C 21/3811; G01C 21/3841

(57) ABSTRACT

REVRD is a real-time emergency vehicle route display system that enhances road safety by alerting drivers to active emergency routes. It receives live routing data from emergency vehicles' in-built GPS during emergency runs and processes this data to detect active routes near drivers, triggering visual and audible alerts. The emergency vehicle's route is overlaid on in-car and smartphone navigation displays, prompting timely driver actions to clear the path. REVRD integrates seamlessly with existing platforms via standardized APIs and supports diverse communication protocols, including cellular, wireless, and satellite. By leveraging existing technologies in emergency vehicles and third-party systems, the invention minimizes additional hardware, reduces traffic congestion, and improves emergency response efficiency. Its scalable, modular design is adaptable to various environments, making it ideal for municipalities, GPS service providers, and navigation application developers.

### ORIGIN OF THE INVENTION

The invention was conceived to address the challenges drivers face when emergency vehicles navigate through congested areas. Developed independently, it aims to improve existing alert systems that often fall short of providing comprehensive guidance beyond sirens and lights. Emergency vehicle drivers frequently encounter significant stress and challenges, such as navigating heavy traffic, ensuring the safety of other drivers, and maintaining rapid response times. These difficulties highlight the need for a more effective system to aid both emergency vehicle drivers and the public in clearing the way during critical situations.

### BACKGROUND OF THE INVENTION

Conventional GPS and mapping applications are designed for general navigation and route optimization but do not adequately address emergency vehicle situations. In emergency vehicle scenarios, drivers may be unaware of the precise route taken by approaching emergency vehicles, resulting in delayed responses and increased congestion. This deficiency prompted the development of a system that notifies drivers of active emergency routes and displays these routes in real time.

### DESCRIPTION

The present invention, REVRD (Real-Time Emergency Vehicle Route Display), is a software-based system that enhances emergency response efficiency and public safety by integrating real-time emergency route data into existing in-car and smartphone navigation interfaces. REVRD receives real-time route information from emergency services and converts this data into actionable alerts and visual overlays displayed on standard GPS navigation systems.

In one embodiment, the system utilizes standardized application programming interfaces (APIs) to seamlessly interface with popular navigation applications-such as Google Maps, Apple Maps, and Waze. When an emergency vehicle activates its emergency mode, REVRD transmits its planned route, which is then prominently highlighted on civilian navigation displays using distinct visual cues (for example, a colored overlay). In conjunction, the system advises alternative routes for civilian drivers, enabling them to avoid the emergency path.

To ensure reliable and timely communication under varying network conditions, REVRD employs a multi-channel communication strategy. It utilizes cellular networks for wide-area coverage, Wi-Fi for intermediate-range, low-latency data transmission where available (e.g., in urban centers or public areas), and Bluetooth for localized, short-range alerts. This tiered approach ensures that emergency notifications and route updates are delivered regardless of the communication medium available.

Designed for licensing to municipalities, GPS manufacturers, and navigation app developers, REVRD is implemented using preexisting technological infrastructure and does not require additional hardware installations. This scalable and cost-effective solution improves emergency vehicle routing, reduces congestion, and increases overall roadway safety by coordinating driver responses during critical situations.

### BRIEF STATEMENT OF THE INVENTION

REVRD is a real-time driver notification and route visualization system for emergency vehicles. It alerts drivers to active emergency routes and displays the emergency vehicle's route, enabling them to take immediate actions such as selecting an alternative path or safely pulling aside.

### SUMMARY OF THE INVENTION

The present invention comprises:
(a) An alert module configured to notify drivers of an active emergency route, providing timely and accurate information to ensure they can take appropriate actions.
(b) A visualization component configured to display the emergency vehicle and its intended path on a digital map interface, using distinct visual cues to highlight the route.
(c) A data integration strategy that leverages existing GPS and navigation platforms, ensuring seamless integration with popular navigation applications such as Google Maps, Apple Maps, and Waze.

The REVRD system enhances road safety by reducing response times for emergency vehicles and providing drivers with clear, real-time guidance. This system not only improves the efficiency of emergency responses but also helps in reducing traffic congestion and ensuring the safety of all road user

### OBJECT OF THE INVENTION

The primary object of the invention is to provide drivers with timely, reliable, and actionable information regarding the route of an approaching emergency vehicle, thereby enabling them to quickly and safely clear the way. Additional objects include:
Enhancing the efficiency of emergency response by reducing traffic congestion.
Facilitating seamless integration with existing navigation infrastructures through standardized data licensing and system adaptation protocols.

### FIELD AND BACKGROUND OF THE INVENTION

This invention relates to the fields of emergency response systems, automotive navigation aids, and real-time data communication. It addresses shortcomings in current navigation technologies—such as delays and static routing—by offering a dynamic method for real-time route notification and visualization during emergency events. This enhanced approach not only improves the timeliness of the displayed information but also supports more effective driver responses and overall safety.

### PRIOR ART/DESCRIPTION OF THE PRIOR ART

Existing navigation systems—comprising both smartphone-based applications (e.g., Google Maps, Apple Maps, and Waze) and integrated in-car navigation platforms—primarily rely on static map data and real-time traffic information to determine optimal routes. However, these systems do not incorporate real-time emergency service data or actively communicate emergency vehicle routes to drivers. Consequently, the prior art does not provide a seamless, integrated method for alerting drivers—whether using a smartphone or an in-car navigation system—about approaching emergency vehicle routes, nor does it furnish detailed, actionable guidance based on dynamic, live data from emergency services.

### BRIEF DESCRIPTIONS OF DRAWINGS/FIGURES

FIG. 1: is a block diagram of the REVRD system illustrating the flow of real-time data from emergency services to the civilian driver's navigation interface. It shows how an emergency vehicle's GPS data is first captured by a GPS Data Module and transmitted to a central cloud server. The data is then disseminated via multiple communication channels—cellular, Wi-Fi, and Bluetooth—to a Dynamic Route Optimization Module, which computes the emergency route and alternative routes. Finally, this information is visually overlaid on existing in-car and smartphone navigation systems to alert drivers and guide them away from the emergency path.

FIG. 2: comprises two images that illustrate how the REVRD system's emergency route overlays appear on navigation interfaces. In these images:

FIG. 2A shows a smartphone-based navigation application (such as Google Maps, Apple Maps, or Waze) where the emergency route is visually highlighted—using distinct texture overlays (e.g., Angled stripes)—while alternative routes are marked with different colors to guide civilian drivers away from the active emergency path.

FIG. 2B presents an integrated in-car navigation system display with a similar overlay. In this image, the emergency route is clearly indicated with prominent visual cues, and “STOP AT THE NEXT INTERSECTION” command concurrently displayed to prompt drivers to take direction or safer detours.

### BEST MODE FOR CARRYING OUT THE INVENTION

The best mode for implementing REVRD is achieved by licensing its core conceptual framework to third-party developers and navigation system providers. In one preferred embodiment, these parties integrate the REVRD system into their existing infrastructure—such as in-car navigation systems and smartphone-based digital maps—without requiring additional hardware installations. This approach ensures that the software execution remains consistent across platforms, with only minor differences (for example, variations in the specific graphical representation of an emergency vehicle) that do not affect the fundamental operation of the invention.

Key integrated components include:
Real-Time Data Feed Interface: A software module that receives live emergency route data from emergency services via standardized APIs. This interface leverages multi-channel communication—including cellular networks for broad coverage, Wi-Fi for intermediate-range low-latency data transmission in network-rich environments, and Bluetooth for short-range localized alerts—to ensure secure and timely dissemination of information.
Driver Notification Module: A component that processes the incoming real-time data and delivers actionable alerts (e.g., “Pull to the right lane” or “Stop at the next intersection”) directly to the driver's device. These notifications can be seamlessly incorporated into existing navigation interfaces on both smartphones and in-car systems.
Route Visualization Overlay: A dynamic overlay mechanism that integrates with digital maps to highlight the emergency vehicle's planned path using distinct visual cues (such as bright or flashing colored overlays), while simultaneously displaying alternative routes for civilian drivers. This visualization ensures that the emergency corridor is clearly delineated and prompts drivers to take appropriate detours.

This software-based solution is designed to be adaptive and scalable. It supports continuous real-time updates, adapts to emerging communication standards, and ensures data security through advanced encryption protocols. By licensing the REVRD framework, municipalities, GPS manufacturers, and navigation app developers can rapidly incorporate the technology into their platforms, enhancing emergency response coordination and overall roadway safety without significant technical disruption.

While the above embodiment represents the preferred mode of implementation, it is understood that various modifications—such as alternative graphical representations, routing algorithms, or communication channel configurations—may be employed without departing from the spirit and scope of the invention.

### DETAILED DESCRIPTION OF THE INVENTION

The present invention, REVRD (Real-Time Emergency Vehicle Route Display), is a software-based system designed to enhance emergency response efficiency and public safety by leveraging existing in-car navigation systems and GPS-enabled smartphones.

The system receives real-time route data from emergency services and converts that data into actionable alerts and visual overlays on standard navigation interfaces. Unlike traditional solutions requiring hardware modifications, REVRD is intended for integration via licensing with municipalities, GPS manufacturers, and navigation app developers.

In one exemplary embodiment, when an emergency vehicle (such as an ambulance, fire truck, or police car) activates its emergency mode, its built-in GPS unit continuously generates location, speed, and trajectory data. This data is collected by a dedicated GPS Data Module and transmitted to a central cloud server via standard communication protocols. The cloud server aggregates this information, making it available for real-time processing.

A Dynamic Route Optimization Module processes the collected GPS data along with current traffic conditions to calculate and update the optimal route for the emergency vehicle. Concurrently, it determines alternative routes for nearby civilian drivers, ensuring that the designated emergency corridor remains clear. The computed emergency route is transmitted to civilian navigation systems, where it is visually highlighted with distinct markers, while alternative routes are communicated to guide drivers away from the emergency path.

REVRD employs a multi-channel communication strategy to ensure reliable and timely dissemination of route and alert information. Cellular networks provide broad-area coverage, while Wi-Fi offers intermediate-range, low-latency communication in areas with established network infrastructure such as urban centers and public spaces. Bluetooth is used for localized, short-range alerts, particularly within a few hundred meters of the emergency scenario. The Wi-Fi channel plays a critical role by bridging the gap between the localized range of Bluetooth and the wider coverage provided by cellular networks, thereby reducing latency and offloading data traffic in network-rich environments.

Integration with third-party navigation apps—such as Google Maps, Apple Maps, and Waze—is achieved using standardized application programming interfaces (APIs). When the emergency vehicle's route is calculated, the system transmits real-time notifications, including actionable instructions (for example, “Pull over to the right” or “Stop at the next intersection”), to civilian devices. These notifications are then visually overlaid on existing navigation displays, clearly indicating the emergency route and suggesting alternative pathways for civilian drivers.

Security and data integrity are paramount; hence all communications among the emergency vehicle's data collection unit, the central cloud server, and the cellular, Wi-Fi, and Bluetooth modules are encrypted and transmitted over secure channels.

Although the embodiments described herein represent a preferred mode of implementing the invention, various modifications and adaptations may be made without departing from its scope and spirit. For example, additional communication channels or enhanced algorithms for route optimization may be incorporated as technological advancements occur.

### DETAILED DESCRIPTION OF THE DRAWINGS

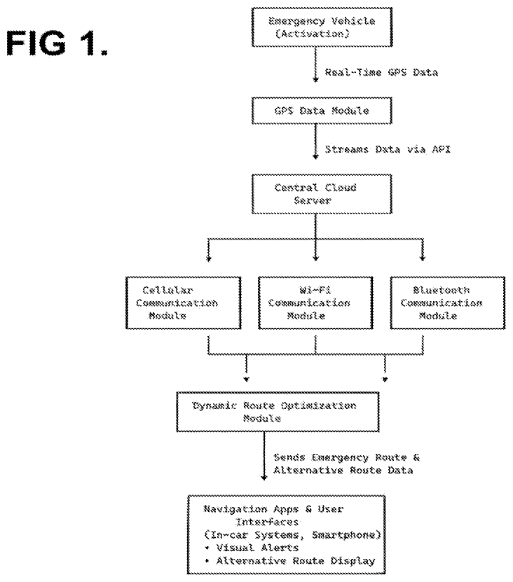

FIG. 1—A block diagram illustrating the overall architecture of the REVRD (Real-Time Emergency Vehicle Route Display) system. The figure depicts the following key components and data flows:
Emergency Vehicle Activation: an emergency vehicle activates its emergency mode, generating real-time GPS data.
GPS Data Module: This module receives and processes the GPS data (including location, speed, and trajectory), then streams the information via standardized APIs.
Central Cloud Server: The processed data is transmitted to a central cloud server, which aggregates the information for further processing.
Multi-Channel Communication Modules: From the central server, the system employs three complementary channels:
   A Cellular Communication Module for broad-area data dissemination.
   A Wi-Fi Communication Module for intermediate-range, low-latency communication in network-rich areas.
   A Bluetooth Communication Module for short-range, localized alerts.
Dynamic Route Optimization Module: Data from the communication channels converges here, where the system computes the optimal emergency route and determines alternative routes for civilian drivers.
Navigation Apps & User Interfaces: The resulting information is transmitted to civilian vehicles. The emergency route is visually highlighted on both smartphone navigation apps (such as Google Maps, Apple Maps, or Waze) and integrated in-car navigation systems, with clear visual cues and alternative route suggestions.

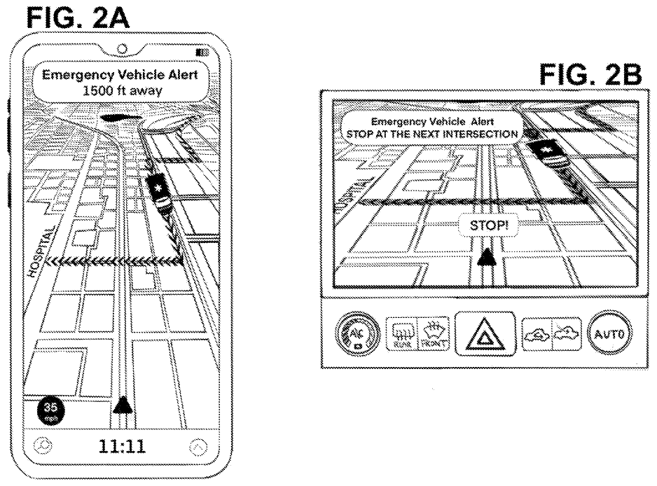

FIG. 2 illustrates two distinct embodiments of the navigation display overlays generated by the REVRD system, demonstrating how emergency route information is presented to users in real time.
FIG. 2A—Smartphone-Based Navigation Overlay: this figure shows a screen capture from a popular navigation application (e.g., Google Maps, Apple Maps, or Waze) running on a smartphone. In the image, the emergency route is prominently highlighted using a bright, distinct color (such as red), in this figure, black. that differs from normal routing colors. The overlay not only marks the active emergency corridor but also displays visual icons and text instructions, such as “1500 ft away”, “Pull over”, “Stop”, or “Avoid this route,” adjacent to the highlighted path. Additionally, alternative routes are indicated by differently colored lines (for example, blue or green) to guide civilian drivers away from the emergency path. This detailed view underscores the system's ability to integrate seamlessly with existing GUI elements on smartphone applications without requiring any hardware modifications.
FIG. 2B-Integrated In-car Navigation Display Overlay: this figure depicts the overlay as it appears on an in-car navigation system. In this embodiment, the emergency route is similarly delineated with a distinct colored overlay and bold markings, ensuring that it stands out from the regular route display. The diagram will show additional visual cues such as directional arrows and a segmented timeline view that indicates dynamic updates as the emergency progresses. Furthermore, it includes on-screen prompts, in this example “STOP AT THE NEXT INTERSECTION” and another prompt ‘STOP” and can provide alternate routing suggestions by marking secondary streets or detour options, ensuring that drivers receive clear, actionable guidance. The detailed interface demonstrates how the REVRD system overlays emergency data onto the vehicle's proprietary navigation interface while maintaining clarity and ease of use.

Overall, FIG. 2 provides a comprehensive view of how the REVRD system visually communicates critical emergency route data across multiple platforms. It illustrates the full integration of dynamic route information, actionable prompts, and alternative navigation suggestions, which together ensure that drivers are both informed and guided to clear the emergency corridor effectively.

1. A method for alerting vehicle drivers to an active emergency route, comprising:
(a) receiving real-time emergency route data from an emergency vehicle, wherein the data is automatically generated by the emergency vehicle's in-built GPS system when the vehicle initiates navigation for an emergency; (b) processing the received data to determine when an emergency route is activated in proximity to a driver's current location; (c) generating a driver alert based on the processed data, the alert comprising at least one of a visual notification and an audible notification; and (d) displaying an overlay representing the emergency vehicle's planned route on a digital navigation interface accessible to the driver.

2. The method of claim 1, wherein the displaying step comprises integrating the emergency route overlay into an existing GPS-based navigation application, the application being implemented on at least one of an in-car navigation system or a smartphone-based navigation system.

3. A system for providing real-time emergency route notifications, comprising: (a) a data acquisition module configured to receive real-time emergency route data transmitted from an emergency vehicle's in-built GPS system when the emergency vehicle initiates its route; (b) a processing unit operable to analyze the received data and to determine when an emergency route has been activated in a region proximate to a driver's vehicle; (c) an alert generation module configured to produce and transmit a driver alert based on the analyzed data; and (d) a visualization module configured to display an overlay delineating the emergency vehicle's planned route on a digital navigation interface
